(19) United States
(12) Patent Application Publication
(10) Pub. No.: US 2010/0189328 A1
(43) Pub. Date: Jul. 29, 2010

(54) METHOD OF AUTOMATICALLY ACQUIRING MAGNETIC RESONANCE IMAGE DATA

(75) Inventors: Peter Boernert, Hamburg (DE); Jochen Keupp, Rosengarten (DE); Peter Koken, Hamburg (DE); Daniel Bystrov, Hamburg (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/601,530

(22) PCT Filed: May 26, 2008
(86) PCT No.: PCT/IB08/52055

§ 371 Date: Nov. 24, 2009

(30) Foreign Application Priority Data
May 31, 2007 (EP) 07109264.7

(51) Int. Cl. G06K 9/00

(52) U.S. Cl. 382/131

(57) ABSTRACT

The invention relates to a method of automatically acquiring magnetic resonance (MR) image data (500; 504) of an object located on a support (140), the support (140) being adapted to be moved to an image acquisition region of an MRI apparatus, the method comprising: specifying an area of interest (510) to be detected by the MRI apparatus, automatically moving of the support (140) in the direction towards the image acquisition region, automatically acquiring of first MR image data (500; 504) with a first resolution for identification of the area of interest (510) in the acquired image data (500; 504), automatically acquiring of second MR image data of the identified area of interest (510) with a second resolution, wherein the first resolution is lower than the second resolution.

### TECHNICAL FIELD

The invention relates to a method of automatically acquiring magnetic resonance image data, a magnetic resonance imaging apparatus for automatically acquiring MR images of an object and a computer program product.

### BACKGROUND AND RELATED ART

Magnetic resonance imaging (MRI) is one of the major imaging techniques in medicine. MRI is capable of generating detailed images of soft tissues. In MRI, specific properties of the various compounds found inside tissues are used to generate images, e.g. water is most commonly used for this purpose. When subjected to a strong external magnetic field, the protons ¹H will align with this external field, resulting in a net magnetic moment. After excitation by radio frequency RF pulses, this magnetization will generate an RF signal that can be detected. This RF signal is characterized by a frequency that is related to the magnetic field strength. Therefore, magnetic field gradients are used to encode a spatial information which is needed to reconstruct the image from detected signals.

MRI becomes more and more popular in clinical diagnostics. With the inherent wealth and variability of scan parameters, protocols and anatomies to be scanned, the operation of an MRI system is relatively complex. Improvements in the ease of use, workflow and efficiency of MRI systems are increasingly important considering also the diminishing degree of operator skills, which is currently reported and predicted for the future. With many more MR systems being installed, operators might even become responsible not only for one MRI system but for a number of them running in parallel. Furthermore, with an increasing number of available MRI systems, operators might have to run examinations on different vendor platforms or even on different modalities. In the future, one could further expect an increasing number of preset examination procedures (sets of protocols), applied to answer particular diagnostic questions according to fixed and established schemes, which will also be related to reimbursement issues. Therefore, there is obviously a need to automate those kinds of examinations to simplify the operation and to enhance the workflow.

According to the current state of the art, patient positioning is performed using different means like the light visor to manually position the patient in the sensitive volume of the MRI scanner. Subsequently, the operator triggers a local scouting scan with the table the patient is positioned on at rest, to acquire course anatomical information. In some cases this acquisition has to be repeated, because the anatomy of interest was not adequately covered. The anatomical information allows the operator to manually plan the scan geometry. More recently, automated model-based planning was introduced, using the scouting scan information to propose a suitable scan geometry for predefined target anatomies, which can be corrected and trained by the operator.

U.S. Pat. No. 7,145,338 B2 discloses a method for implementation of magnetic resonance examination of a patient with an imaging medical magnetic resonance apparatus with a moveable patient bed. U.S. Pat. No. 6,195,409 B1 discloses a system and method for automatic scan prescription involving initially performing at least one localizer scan for an object being imaged.

### SUMMARY OF THE INVENTION

The present invention provides a method of automatically acquiring magnetic resonance (MR) image data of an object located on a support, the support being adapted to be moved to an image acquisition region of an MRI apparatus, the method comprising specifying an area of interest to be detected by the MRI apparatus, automatically moving of the support in the direction towards the image acquisition region, automatically acquiring of first MR image data with a first resolution for identification of the area of interest in the acquired image data, and automatically acquiring of second MR image data of the identified area of interest with a second resolution, wherein the first resolution is lower than the second resolution.

By acquiring the first MR image data during the entering of the patient table (support) into the MR scanner bore (travel-to-scan phase) it is possible to automatically detect for example a certain organ like the liver, kidney or spine, selected by the operator in advance, which reduces the operator's effort during scan planning and execution and speeds up the scanning procedure which increases the patient's comfort. Just after the patient has been positioned on the table, the only operator action is to select a certain organ, specify a predefined set of examination protocols (e.g. ExamCard) and to push a single button which initiates the automatic scanning procedure automatically. Thereby, the selection of a predefined set of examination protocols is optional. The MRI scanner itself may automatically decide which best suitable examination protocol to use with respect to the selected organ, or the operator may be provided a set of examination protocols selected by the MRI scanner suitable for scanning of the respective organ. Depending on the information the operator wants to preferably extract from acquired MR images, specific examination protocols out of the set of examination protocols may be selected by the operator. Thereby, the examination protocols can for example be standardized preset protocols tailored to a respective hospital.

For automatic acquiring of the first MR image data, low resolution continuously moving table (CMT) imaging is performed during the travel-to-scan phase. Thus the first MR image data is acquired while the patient approaches the iso-centre of the MR scanner bore. 3D (or multi-slice) CMT scanning is performed, preferable with isotropic spatial resolution, using the MR body coil (and/or surface coils) for signal reception. For more general details on CMT imaging refer to Shankaranarayanan A, Herfkens R, Hargreaves B M, et al. Magn Reson Med. 2003; 50:1053-60; Kruger D G, Riederer S J, Grimm R C, Rossman P J. Magn Reson Med 2002; 47: 224-231; Aldefeld B, Börnert P, Keupp. Magn Reson Med. 2006; 55:1210.

It is also possible, that 3D (or multi-slice) CMT scanning is performed with a spatial resolution, which is adapted to the anatomy scanned. This resolution adaptation is steered by an anatomy detection process that is running in parallel to the MR data acquisition.

It has to be mentioned again, that the method of acquiring magnetic resonance image data is performed fully automatically by the MRI apparatus. That means, that the MRI apparatus does not only support an operator with an automatic detection of body parts and organs of the human body substituting a state of the art local scouting scan to acquire course anatomical information and to ease the manual planning of the scan geometry of the operator. In contrary, the method according to the invention additionally allows to fully automatically scan an MR patient with means of the first low image resolution MR data acquisition after an area of interest has been specified by an operator, the scanning being performed without any intervention or interaction of an operator regarding the MR scanning process. After the patient is automatically positioned within the MR magnet bore based on analysis of the first MR image data which identified the specified area of interest, the MRI apparatus automatically starts one or multiple high resolution MR imaging procedures without any user interaction in order to acquire the (or multiple) second MR image data of the identified area of interest. These second MR image data may then further be used for physicians for the purpose of medical diagnosis.

In accordance with an embodiment of the invention, the area of interest is specifiable as an anatomic structure. Such a anatomic structure may be for example a certain organ like the liver, kidney, spine, etc.

In accordance with an embodiment of the invention, the area of interest is specifiable as an anatomic anomaly. In case the area of interest is specified by an operator as “anatomic anomaly”, the outcome of the 3D whole body scan and the organ and target identification process can be used to test if a patient shows serious anatomical abnormalities, which could be of diagnostic interest and could make manual planning necessary. If a manual planning is not necessary, the entire following diagnostic scanning process can be done automatically without using interaction. It is also possible to include all verbal commands given by the scanner itself, if desired. It should be mentioned, that additional automatic detection of anatomic anomalies is also possible during a normal scout scan for detection of an anatomic structure.

In accordance with an embodiment of the invention, the patient support is able to move continuously. Using such kind of support (table, bed), a patient has to be laid on the support only once on the very beginning of the MR scan without accurate patient positioning. From this moment on, the support is automatically moved by the MR scanner to respective positions for acquiring MR image data. It has to be mentioned, that for performing the MR scout scan for acquiring the first MR image data, the term ‘continuously moving’ of the support has to be either understood as a stepwise moving of the support, since a still standing support can be used in order to acquire a momentary image regarding the first MR image data for identification of the area of interest in the acquired image data, or it can be understood as a smooth movement of the support during the MR data acquisition. In the latter case, a support motion correction of the MR images recorded while moving the support has to be performed as well known in the art.

In accordance with an embodiment of the invention, the first MR image data are acquired in real time during the continuous moving of the support. Generally spoken, image reconstruction and organ/anatomy identification is performed in real time in parallel to the data acquisition, allowing to stop the table motion once the target anatomy is identified and preferably already lies fully in the sensitive volume of the MR scanner. A real time display can be added to show relevant data (e.g. a coronal or sagittal view of the MR data or an adapted anatomic atlas) in the user interface with the anatomical features highlighted (outlined, organ atlas super imposed etc.) once image processing identifies them. To enable this feature, image reconstruction is also performed in real time. After each sub-k-space acquisition, a new image reconstruction is performed triggering a new organ identification process using e.g. a truncated whole body anatomy atlas on the updated image data.

In accordance with an embodiment of the invention, the method further comprises automatic adjusting of MR image acquisition parameters for acquisition of the first and/or the second MR image data. Thereby, the automatic adjusting of MR image acquisition parameters is based on analysis of the acquired first and/or second MR image data. Since the 3D CMT scan, terminated after target anatomy recognition, gives local information about a found target anatomy and global information about other parts of the patient, this information and the obtained preliminary preparatory parameters can be used to optimize the (geometry) planning phase and the preparation phase of the diagnostic scan to be subsequently performed. For this purpose, an interaction may take place with the predefined scout scanning protocol in the selected set of examinations (ExamCard). These conventional scout scans could be skipped, if the information is already available and sufficient from the CMT scanning phase.

Especially an automatic adjusting of MR image acquisition parameters for acquisition of the second MR image data is necessary, since the acquisition of the second MR image data is typically very specifically adapted for a certain organ to be scanned. This may include the adjustment of echo times for respective pulse sequences, repetition times, image data averaging and also adjusting the voxel size (3D pixel) of data acquired during the second MR image data acquisition, slices, REST-slabs (regional signal suppression), shim volumes, etc. For these objects, fold-over checks, especially necessary in double-oblique scanning also for SENSE scans (sensitivity encoding) can be performed and scan parameters can be modified accordingly (FOV, REST regime).

Adjusting of MR image acquisition parameters for acquisition of the first MR image data is not crucial. The conventional scout is preferably performed automatically including full or adapted preparation phases. Based on the already available geometric information from the scout scan, the geometry of the high resolution scan (second MR data) can be adjusted, e.g. to optimize input for SmartExam type scan geometry planning. Thereby, in the given scenario, the light visor is no longer necessary.

CMT scout scanning should be based on patient independent system parameter settings, because an MR signal is only available after first anatomy parts have entered the field of view. This means that scanning is performed with sub-optimally tuned system parameters. They are chosen to be safe to avoid e.g. spectrometer saturation, and the like, for any possible patient constitution. These system settings may be chosen to incorporate updates or an update history from previous examinations on the same or other patients. Optionally, few and short preparation phases are performed, integrated in the CMT scanning sequence for parameter update. Those measurements might be obtained either off iso-centre or after the first anatomy part has reached the iso-centre. Basic assumptions on simple models can also be used to estimate decent preparatory parameters based on only a few updates.

In accordance with an embodiment of the invention, the identification of the area of interest is performed using image processing, wherein the identification of the area of interest is performed with means of an anatomical database and/or a susceptibility database. The anatomical database may for example comprise an anatomical atlas which allows to use a model driven patient recognition system for using image processing to identify acquired anatomical structures. Thereby, organ identification and/or segmentation during the whole body scout gives additional information about a patient, which is additionally helpful to characterize the patient's state of health. This includes measuring of for example the lung volume, the size of the liver, spatial position of the kidney, measurements of organ volumes, dimensions, masses etc.

It should also be mentioned, that whole body scout information can also be used to plan anatomical structures that are larger than the homogenous region of the scanner. Spine or peripheral angiography-type examination are an example. Based on the whole body CMT scout data, the entire diagnostic examination can be planned automatically, which can use an extended virtual FOV based on a multi-station scan or a CMT scan.

In accordance with an embodiment of the invention, the method further comprises real time susceptibility mapping based on analysis of the first MR image data, wherein in case of identification of a susceptibility distortion the MRI scan is interrupted and/or the MRI scanning parameters are adjusted and/or the moving direction of the support is inverted and/or a signal is generated by the MRI apparatus indicating the identification of a susceptibility distortion.

Such kind of real time susceptibility mapping is necessary since all kinds of for example metal materials could be placed inside or around a patient during an MR examination. Such kind of metal materials may comprise implants, pacemakers, parts of patient's clothes like buttons or zippers, jewellery, piercings etc which can substantially degrade the image quality or in case of ferromagnetic parts could even harm the patient. In addition the deposition of RF energy can lead to strong heating of the metal objects, resulting in a risk of serious burns to the patient. With increasing patient throughput, diminishing degree of operator skills and mistakes in the anamnesis, this may happen more often in the future. Also metal hardware is commonly implanted in orthopedic surgery. The number of patients with implants is growing rapidly with improvements in surgical technology and with the ageing population. For implants applied a long time ago, the exact size, position and material composition may not be known anymore.

State of the art MR systems only allow a very simple check on the presence of metals in a human body using the f₀ determination. If the difference between two f₀ measurements is above a certain threshold, it is assumed that material is placed in the region under examination and the operator is informed about that. However, if the metal object is small and not inside or near the volume excited during the f₀ determination scan, it will not be detected by this method. Furthermore, the operator cannot be informed about size and position of the metal.

Together with image reconstruction and by using a susceptibility atlas of the human body, abnormal strong gradients and signal voids can be used to identify metal objects. It is additionally helpful, if the operator is informed about position and size of metal objects in the body region under examination prior to the main data acquisition. Such information can be shown to the operator as a colored overlay on anatomic images in real time. He can be advised to remove the metal if possible, to adjust the plan scan (modified geometry, reduced SAR) or to stop the examination for safety reasons. A number of those decisions could be done automatically without user interaction. This would simplify the workflow and make MR imaging simpler and safer. The information about the amount and location of metal can also be used to make the preparation measurements more robust and more reliable by for example excluding those regions for f₀ (central resonance frequency) determination.

Depending on the dangerousness of the presence of a susceptibility distorting object, the MRI scanner may itself decide if an MRI scan can be continued with respective adjusted data acquisition parameters, or if in case the MRI system detects a potentially high dangerous object the MRI system itself can decide to invert the moving direction of the support in order to move a patient out of the area of danger as fast as possible. Also, depending on the kind of magnet being used for performing the MRI scanning, a complete, but controlled shutdown of the magnetic field might be possible, especially for non-superconducting magnets.

Regarding the technical implementation of the CMT scout imaging-based metal detection, once a sub-k-space data acquisition in the CMT scan is finished and 3D data are reconstructed, the data is analyzed using susceptibility mapping algorithms. Steep gradients in the signal phase and huge signal voids are indicators for metal objects. If e.g. the phase gradient is above a certain threshold, a warning may be shown to the operator or a respective action may be automatically performed by the MR apparatus. Since the susceptibility variation induced by a patient itself varies strong over the whole body (e.g. strong gradients at the shoulders), the threshold should be adjusted according to an anatomical atlas.

Characteristic slices of the 3D dataset or volume rendered images can also be shown to the operator, including a colored overlay indicating regions where metallic material is assumed. Depending on the size and the position of the material, different actions can be proposed. For example if the metal object is small and located on the body surface, it is probably related to the clothes etc and can be removed. If the metal is inside the body near the bones (according to an anatomical atlas), it is probably an implant. Special scans with high SAR can be prohibited in this case for safety reasons or they can be accordingly modified to reduce the risk of overheating of the local examination area, or the total examination can even be terminated. If in such a situation the operator or an automatic algorithm decides to continue the examination, the information about the regions with metal material can be used as already mentioned above to optimize the preparation phase. For example, these regions can be excluded during the f₀ determination, since no reasonable f₀ estimation is possible at a presence of metal.

The whole processing with image reconstruction, registration, mapping, steep gradient detection, can be performed in real time in parallel to the data acquisition. A real time display shows image slices in the user interface with color overlay showing the identified metal object. This allows also aborting the scan directly by an operator, when a potential safety problem is detected by the operator itself.

In accordance with an embodiment of the invention, the moving of the support is stopped at identification of the area of interest. However, an organ can be only reliably detected, if the full corresponding image data has been collected, which typically means, that the table has already moved further than necessary to position the target organ in the iso-centre. This comprises the usage of just in time organ detection to minimize or avoid table rollback after organ recognition. There are several options to address this challenge. One possibility is an embodiment, wherein acquisition of first MR image data is performed at a first zone of the image acquisition region, and wherein the acquisition of the second MR image data is performed at a second zone of the image acquisition region, wherein the first zone is spatially located ahead of the second zone with respect to the direction of support movement. Therewith, image data acquisition can be performed in a region displaced from the iso-centre, shifted opposite to the table motion direction. Thus, information is obtained about the anatomy, which will soon reach the iso-centre. Target anatomy/organ placement in the iso-centre after the automatic identification can be achieved by appropriate stopping of the table motion. This approach avoids a table rollback to place a target anatomy in the magnet's iso-centre.

Another possibility to allow for just in time organ detection is an embodiment, wherein the first MR image data acquisition is performed using keyhole type sampling. In general, keyhole type sampling is used for dynamic imaging with a contrast medium. The advantage is that the keyhole technique increases temporal resolution without a significant loss of spatial resolution by limited data acquisition. Keyhole Fourier imaging updates the low spatial frequencies at the original full, high resolution dataset. The high spatial frequency content of the image is constant in time so that its updating would be unnecessary. A method for performing rapidly high resolution MR imaging using keyhole type sampling is known for example from WO 99/14616.

During sampling of each individual 3D data block, the k-space centre can be sampled twice or multiple times, by adjusting the k-space trajectory and the timing of the CMT imaging sequence. Keyhole type sampling and reconstruction can be performed to increase the number of image updates per sample block. This concept could also be of interest to reduce potential artifacts in CMT imaging, which usually appear with the periodicity of sampling of data for low-k values.

It has to be mentioned, that keyhole type sampling is only reasonable to be used if the imaged region has not changed too much with respect the last acquisition of the respective full 3D data block. Therewith, the keyhole type sampling can only be used in an interleaved manner between certain 3D data acquisition blocks.

In accordance with an embodiment of the invention, the moving speed of the support is varied with respect to anatomies identified with means of the automatic acquisition of the first MR image data. This also comprises increasing the spatial resolution for acquiring of the first MR image data when the area of interest is expected to be moved by means of the moving support to the image acquisition region.

Since an anatomic detection may be based on a body model and may give immediate estimates about a patient's orientation (feet first, head first) and the potential distance to the target anatomy, once the anatomy detector recognizes that the target anatomy comes into reach, the table speed is decreased and the spatial resolution of the MR data acquisition process is increased to allow reliable organ detection. This can be achieved by increasing the spatial resolution in an isotropic manner, or by switching between different scan modes supporting different resolutions. For example, the scan could start with a 2D sagittal (or coronal, or transversal, or a mixture of them) acquisition sampled at high table speed, which is switched down gradually to acquire more slices at a lower speed once the model driven anatomy detection indicates the target is quite close. It is also possible to switch from the efficient 2D mode to a 3D mode that allows for isotropic spatial resolution supporting the final target identification that triggers the final table positioning process. The transitions between the individual resolution levels can be realized in steps or in a graduated fashion. It is also possible, to completely change the used MRI protocol during the table movement.

In accordance with an embodiment of the invention, the method further comprises automatically providing information regarding an optimal spatial positioning of further MRI receive coils, the further MRI receive coils being adapted for acquisition of the second MR image data. Thereby, providing of the information regarding optimal spatial positioning of the further MRI receive coils is based on analysis of the first MRI image data and/or if the further MRI receive coils are already spatially positioned on the object to be scanned based on analysis of MR image data acquired from the further MR receive coils.

Many MRI examinations apply special surface coil arrays for signal reception and/or transmission, allowing for increased signal to noise ratio imaging acceleration techniques (SENSE, GRAPPA) or novel encoding methods (transmit-SENSE, RF encoding). With an increasing number of applied coil elements, including settings for head-to-toe coil coverage, coil placement or selection of an optimum coil element subset becomes a significant and time consuming part of the clinical workflow.

In case of a scout scan being performed with surface coils being already in place positioned on the patient, the current location orientation of the surface coils can be measured during the scout scan. This can be accomplished by e.g. introducing additional single gradient echoes (applied in x, y, z) into the timing of the respective imaging sequence for acquiring the first MRI image data at regular intervals. As an alternative, the acquisition can be extended to acquire body coil and surface coil images in an interleaved or simultaneous manner in order to obtain coil sensitivity maps. These maps can be processed to extract the individual coil positions/orientations in terms of the centre of sensitivity or the centre of mass.

Previously known coil sensitivity information might also be included in this process. Based on the target anatomy, which was found in the scout scan, the scanner calculates optimal places/orientations for the elements/element groups of a selected type of coil array. In addition, it is possible to automatically select the type of coil array out of all currently available to be preferably used, together with the optimal positioning of its elements/element groups. Since the array was already in place, the system will give advice, if a correction of the placement or even a change of the type of array would be beneficial for image quality (criteria: SNR, homogeneity of SNR, avoid ghosting/striping artifacts, etc). If the operator confirms, the patient will be moved out of the scanner to allow for guided coil replacement.

In case the scout scan is performed without the surface coils being already positioned on the patient, during the scout the body coil is used for signal reception and the surface coils will have to be placed by the operator subsequently. Here, the scout delivers input for an automated procedure to find out the optimal coil selection and position/orientations based on a predefined set of surface coil arrays, which are available in the current clinical setting. The patient will be moved out of the scanner unconditionally for the coil placement. This could also be at the rear side of the scanner in order to avoid prolonged back and forth moving of the patient.

Either in case, for repositioning of the surface coils on the patient or a subsequent positioning of surface coils on the patient, the scanner uses a means of visualization to indicate the optimal coil positions/orientations and thus to guide the operator. This could be accomplished e.g. by a beamer, which projects the coils (light markers or actual coil shapes) onto the patient, or a photonic textile blanket used to cover the patient, which displays markers which have its counterparts on the coil elements/element groups. Alternatively, the table stops at a dedicated position to guide coil placement. Such an automated procedure and visualization or guidance will significantly contribute to the ease of use of the MR system. Finally, the patient can be automatically moved again into the MR scanner bore to an optimized position of the iso-centre relative to the target anatomy.

The complete knowledge about a patient's anatomy and the relative coil positions/orientations, obtained after coil placement and coil element selection can be used as input for scan parameters updates for predefined scan protocols or as a guideline to set up further scan protocols more easily. An example could be the determination of the optimal direction of SENSE reduction or phasing coding steps for parallel imaging, which would be based on the actual size of the target anatomy and the available coil positions in 3-dimensions. Many more protocol parameters depend on the actual patient/coil geometry and could also be included and optimized into automatic updates or proposed values.

In another aspect, the invention relates to a magnetic resonance imaging apparatus for automatically acquiring MR images of an object, the apparatus comprising a support for an object to be imaged, the support being adapted to be moved to an image acquisition region of the MRI apparatus, means for specifying an area of interest to be detected by the MRI apparatus, means for automatically moving the support, means for automatically acquiring of first MR image data with a first resolution for identification of the area of interest in the acquired image data, means for automatically acquiring of second MR image data of the identified area of interest with a second resolution, wherein the first resolution is lower than the second resolution.

In accordance with an embodiment of the invention, the apparatus further comprises means for automatically adjusting of MR image acquisition parameters for acquisition of the first and/or the second MR image data, an anatomical database and/or a susceptibility database and means for automatically providing information regarding an optimal spatial position or further MR receive coils, the further MRI receive coils being adapted for acquisition of the second MR image data.

In another aspect, the invention relates to a computer program product comprising computer executable instructions for performing the method according to the invention.

### BRIEF DESCRIPTION OF THE DRAWINGS

In the following preferred embodiments of the invention are described in greater detail by way of example only making reference to the drawings in which:

FIG. 1 is a block diagram of an embodiment of a magnetic resonance imaging apparatus,

FIG. 2 shows a flowchart illustrating a method of automatically acquiring MR image data of a patient,

FIG. 3 shows a flowchart illustrating a method of automatically providing information regarding a surface coil placement on a patient,

FIG. 4 shows a further flowchart illustrating a method of automatically providing information regarding a surface coil placement on a patient,

FIG. 5 illustrates the accomplishment of an MR image according to the method of the invention.

### DETAILED DESCRIPTION

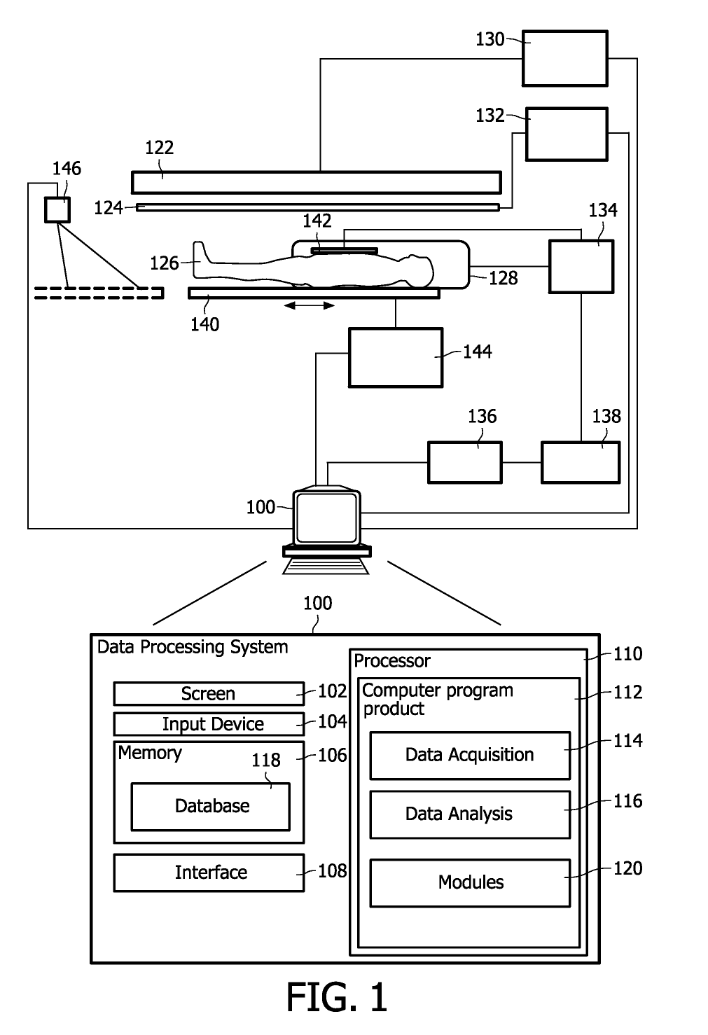

FIG. 1 is a block diagram of an embodiment of a magnetic resonance imaging apparatus. Thereby, only major components of a preferred MRI system which incorporates the present invention is shown in FIG. 1. The magnetic resonance imaging apparatus comprises a data processing system 100, whereby the data processing system 100 typically comprises a computer screen 102, an input device 104 which could be for example a keyboard and a mouse, as well as a single push button which is adapted to allow to run a magnetic resonance imaging sequence completely automatically.

The MRI system in FIG. 1 further comprises a memory 106 and an interface 108. Thereby, the interface 108 is adapted for communication and data exchange with typical hardware MRI components.

These hardware components comprise for example a main field control unit 130 adapted for controlling the main field of the magnetic coils 122. The main field magnet 122 may thereby be adapted as a permanent superconducting magnet or being externally driven and switched on and off for each individual usage of the MRI system. The interface 108 further communicates with a gradient coil control unit 132, wherein respective gradient coils 124 are preferably self-shielded gradient coils for producing gradients along three mutual axis x, y and z. The MRI system further comprises an RF coil 128 electrically connected to an RF control unit 134. Thereby, the RF coil 128 is preferably adapted as an integrated body coil integrated in the magnet bore.

Using an RF generator 138, an RF pulse sequence is generated under the control of the data processing system 100 and therewith for example protons in the body 126 of a person are excited in a predefined manner. The resulting magnetic resonance signal is detected by the same RF coil 128 and transmitted to an amplifier 136, followed by processing of said RF signal by special hardware components like quadrature detectors, mixers etc well known in the art. Thereby, such hardware components can be adapted as additional external hardware units or being implemented into data processing system 100.

The interface 108 is further connected to a bed control unit 144, adapted to control the movement of a bed 140 the patient 126 being positioned on. Thereby, the bed is adapted to move the patient in the direction towards the image acquisition region of the body coil 128.

The data processing system 100 further comprises a processor 110 being adapted to execute computer executable instructions of a computer program product 112. In the present embodiment, the data processing system 100 comprises a computer program product 112 by means of a data acquisition module 114, which is adapted to control the hardware units 122-124 and 128-144. Data acquisition is performed and the acquired data is analyzed by a data analysis module 116 for image reconstruction.

According to the invention, low resolution continuously moving table imaging is performed during travel to scan phase while the patient is moving on the moveable bed 140 towards the image acquisition region. Image reconstruction and organ/anatomy identification is performed in real time in parallel to the data acquisition, using for example an anatomical atlas or database being comprised as a database 118 in the memory 106.

An operator has the possibility, to enter or specify an area of interest of the person 126 to be scanned with the body coil 128. The patient is being moved towards the image acquisition region on the moveable bed 140 and real time scanning is performed while moving the bed 140 acquiring first MR image data with a low resolution for identification of the area of interest in the acquired image data. After the respective area of interest, which could be an anatomic structure or also an anatomic anomaly, is identified by the MRI system, the magnetic resonance apparatus in FIG. 1 automatically acquires second MR image data with high resolution of the area of the identified area of interest.

The computer program product 112 further comprises various modules 120. These modules can for example be adapted to optimize the bed 140 with the patient 126 is positioned with respect to a target organ in the scanner's iso-centre. For example, continuously moving table scout imaging is performed while the patient is automatically moved into the MRI scanner to perform the required study of the selected target organ. Low resolution MRI data is acquired during the table movement, while a model driven patient recognition system using image processing identifies the acquired anatomical structures in parallel. If the algorithm identifies a target organ or a close anatomical structure (e.g. diaphragm for kidneys or liver), due to the module 120 the table velocity is reduced and the acquisition is switched to a higher resolution e.g. from 2D to low resolution isotropic 3D.

The modules 120 can also be used to control a surface coil 142. Such a surface coil can be either positioned before moving the patient for the first time towards the image acquisition region, or if it is planned to use such a surface coil 142 for a high resolution scan, the scanner can give advice to an operator where and how to position the coil 142 with respect to the patients position. In both scenarios, the scanner uses means of visualization to indicate the optimal surface coil 142 position and orientation and thus to guide an operator. This in the present embodiment is accomplished by a beamer 146 which projects the coils shape onto the patient.

Another module 120 may be implemented as a metal detection module. During travel to scan, low resolution continuously moving table scout scanning is performed with real time image reconstruction and real time susceptibility mapping. Together with image registration and a susceptibility atlas also being comprised in the database 118, abnormal strong gradients and signal voids can be used to identify metal objects. For example, if a patient 126 was moved on the bed 140 towards the image acquisition region and a metal part was detected spatially located on the surface of the patient's body 126, it is presumably related to clothing carried by the patient 126. In this case, preferably the bed 140 is automatically moved outside the magnet bore and the data processing system 100 signals for example using an acoustic signal or with means of a visualization on the computer screen 102 to the operator the presence and position of a metal object.

In case the metal is detected inside a body 126 for example near the bones according to an anatomical atlas comprised in the database 118, it is highly probably an implant and special scans with respective scan parameters which could harm the patient due to the development of heat due to the deposition of RF energy can be prohibited by the module 120 in order to prevent injury of the patient 126.

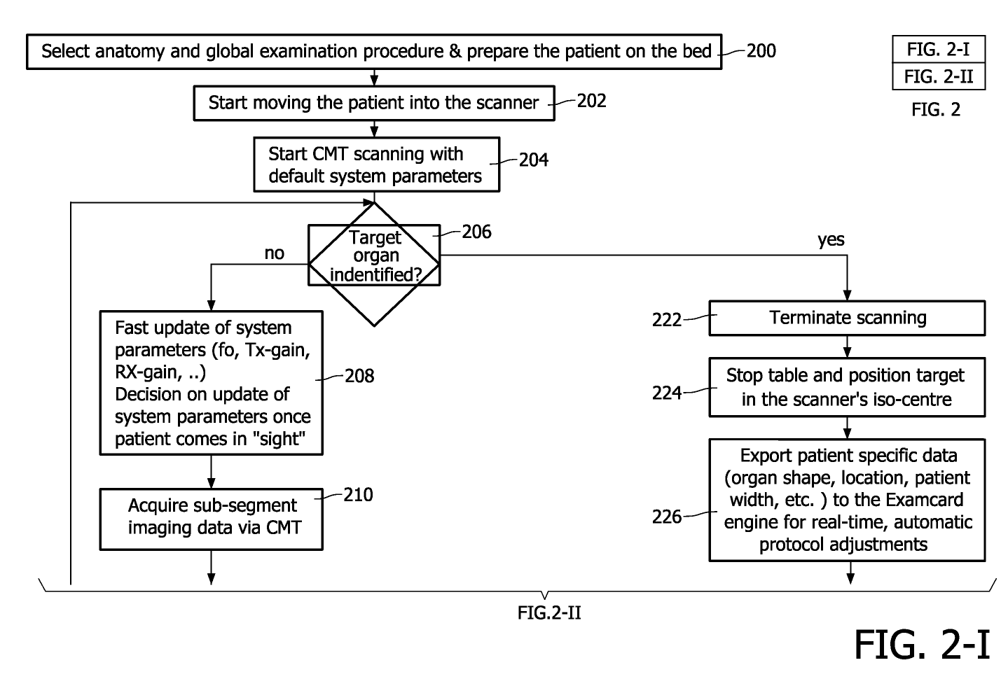

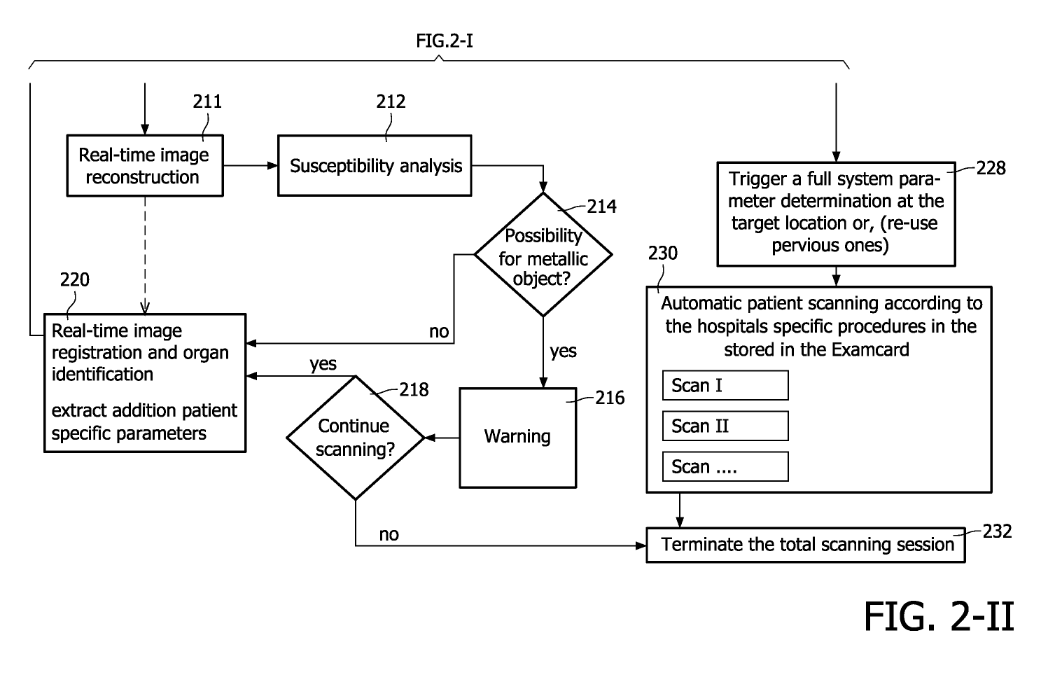

FIG. 2 shows a flowchart illustrating a method of automatically acquiring MR image data of a patient. In step 200, an operator selects an anatomy and optionally a global examination procedure and prepares the patient on the bed. Thereby, selecting the anatomy and global examination procedure may comprise input for example of a certain organ to be imaged, as well as selecting from a list of certain imaging procedures presented by the MR system to the operator a specific scanning protocol, which is for example especially adapted to locate special anatomical features of the organ to be scanned.

In step 202, the operator pushes a single push button to start the examination procedure and the MRI apparatus starts moving the patient into the scanner. In step 204, the MRI system starts the continuously moving table (CMT) imaging scanning with either default system parameters or also possibly with special parameters predefined in step 200 by the MR system operator. However, preferably in order to ease the use of the MR system according to the invention a minimum input of an operator to said MR system is preferred.

Since after immediate starting of the CMT scanning a respective specified target organ has of course not yet been defined, and therefore in step 208 a fast update of system parameters like f₀, TX gain, RX gain etc is performed as a real time optimization of the MR imaging process. Such a decision on update of respective system parameters has especially to be performed once the patient comes in sight the MR detection area, which means that soft tissue structure is detected by the MR system. As soon as the patient comes in sight, in step 210 subsequent imaging data are acquired via the continuously moving table imaging. After each sub-k-space acquisition, a new real time image reconstruction is performed in step 211. This is followed by a real time image registration and organ identification step 220. The new organ identification process using for example a truncated whole body anatomy atlas is performed on the updated image data.

In case the MR system performing the method illustrated in the flowchart of FIG. 2 is further adapted with a susceptibility analysis module, after step 211 with the real time image reconstruction the next executed step may be for example a susceptibility analysis step 212 of the acquired image data. In case due to the susceptibility analysis in step 212, the MR system in step 214 detects that there is a possibility for the presence of a metallic object, the MR system in step 216 generates a warning. This is followed by step 218, where a decision has to be drawn with respect to the detected metallic object if the scanning can be continued or not. Thereby, this decision can be either made automatically by the MR scanning system itself or by an operator. In case the MR system or the operator decides in step 218 to abort the scanning process, the total scanning session is terminated in step 232. However, if there was no metallic object detected in step 214 or if the MR system or the operator decide to continue the scanning in step 218, real time image registration and organ identification is performed in step 220.

The real time image registration and organ identification is accompanied by extracting additional patient specific parameters, also in step 220. This can be especially in the presence of the detection of a metallic object in step 214 extremely useful, since in this case regions containing a metal object can be excluded for f₀ determination.

It should be mentioned, that for a more reliable procedure for performing susceptibility analysis and therewith detecting the presence of metallic objects, step 212 may not already carried out after step 211 but not until the real time image registration and organ identification step 220 has been performed. The reason is, that together with the image registration and a susceptibility atlas of the human body, abnormal strong gradients and signal voids can be used to identify metal objects also with respect to their spatial position with respect to the patients anatomy. This allows for distinguishing between metallic parts originating for example from zippers of cloths being located on the patients body or metallic implants being located in the patients body.

After step 220, the method is looped back to step 206, where it has to be decided again by the MR system if a respective target organ was identified. In case the target organ was not yet identified, the same procedure is repeated with steps 208 to step 220, until such a target organ is identified.

If in step 206 however a target organ was finally identified, the scout scanning is terminated in step 222. This is followed by step 224, wherein the moving table is stopped and the table position is readjusted in order to position the target organ automatically for an optimal MR data acquisition in the scanner's iso-centre. In step 226, patient specific data like organ shape, the organ location, patient width etc. is exported to a special engine for real time automatic protocol adjustments. In step 228 a full system parameter determination at the target location is triggered, if required. Finally, in step 230, an automatic patient scanning according to for example the hospital's specific procedures is performed. Such procedures can be stored e.g. in the MR scanners memory as ExamCards.

Each ExamCard can thereby comprise a specific MR imaging protocol with specific system parameters, scan parameters, geometrical parameters, pulse sequences etc., the parameters being adapted for a certain kind of examination procedure. For example, if the target organ ‘liver’ is selected, the MR system itself may assemble a set of ExamCards specially suitable in order to accurately perform one or multiple MR scans of the desired organ ‘liver’. Alternatively a system operator may assemble a set of ExamCards already in step 200, the set of ExamCards being executed by the MR system in step 230. In yet another alternative, a responsible physician may preassemble a set of ExamCards, transfer them to the MR system which itself due to an association with a patient-ID executes respective MR scans automatically. In this case, even a selection of an anatomy and global examination procedure does not have to be performed by the MR system operator in step 200—the operator only enters the patient ID in step 200 and the MR system itself uses the information transferred to the MR system by the physician for the respective patient with the patient ID in order to automatically perform the imaging steps.

After successful scan of the respective target organ the total scanning session is terminated in step 232.

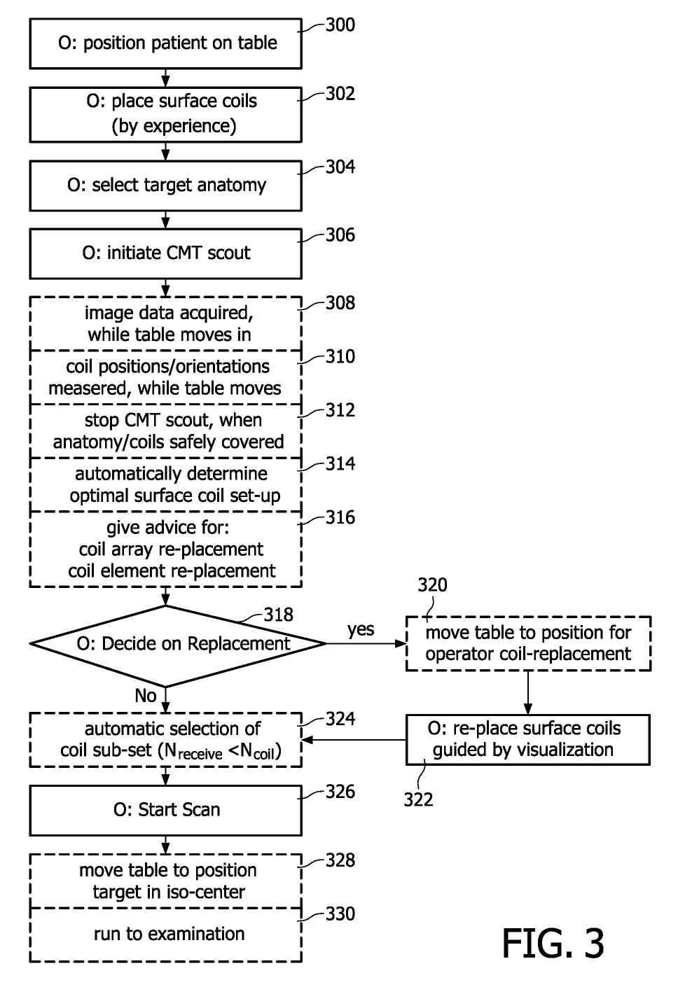

FIG. 3 shows a flowchart illustrating a method of automatically providing information regarding a surface coil placement on a patient. In step 300, an operator positions a patient on the table. This is followed by step 302, wherein the operator places surface coils by his own experience preferably as close as possible to a target anatomy. In step 304 the operator selects the target anatomy from a list provided by the MRI scanning system to the operator. By pressing a respective button, the operator initiates the continuously moving table imaging procedure in step 306.

In step 308, image data is acquired while the table is moving. This allows for measuring and determining coil positions and orientations in step 310 while the table is moving.

The CMT scout is stopped, when the target anatomy and/or the coils are optimally positioned in the magnet bore. The MR system automatically determines an optimal surface coil setup in step 314 and outputs an advice for a coil replacement in step 316.

The information about optimal coil element placement obtained via the scout scan can be additionally used for improved coil element selection. This is particularly beneficial if a selected coil array contains more elements than there are receivers in the MR spectrometer system. The detected coil positions can be visualized in the user interface together with the morphology picture of the patient, or with an idealized atlas for presentation of the patient's anatomy.

In step 318, either the MRI system itself automatically or the operator decides on a replacement or repositioning of the surface coils. If in step 318 it is decided to replace the surface coils, in step 320 the table is moved to a position to allow an operator to perform the coil replacement. This is followed by step 322, wherein the replacement of the surface coils or respectively the re-orientation of the surface coils is guided by a visualization provided by the MR system. Either after step 322, or after the system or the operator decides not to replace the surface coils, an automatic selection of a coil subset is performed in step 324. It is also possible, that the operator itself selects respective coil elements. This is particularly beneficial if a selected coil array contains more elements than there are receivers in the MR spectrometer system. It should also be mentioned that it is possible that the operator may be guided in his decision by an automated MR system advice that may be derived by several criteria like distance to target, meet expected signal to noise ratio, contribution to the current field of view, a current table position and the like. Quantitative analysis of possible coil selection options can also be used for a fully automated selection of the applied coil element subset.

In step 326, the operator starts the scan using the replaced surface coils. However, step 326 may not be necessary, if in step 318 a coil replacement was not decided. In this case, the MR system can immediately start the scanning procedure itself. Either after automatically starting the scanning procedure or after step 326, the MR system automatically moves the table to position the target anatomy in the iso-centre of the MR bore. This is done in step 328, followed by the main examination process performing an MR imaging procedure in step 330.

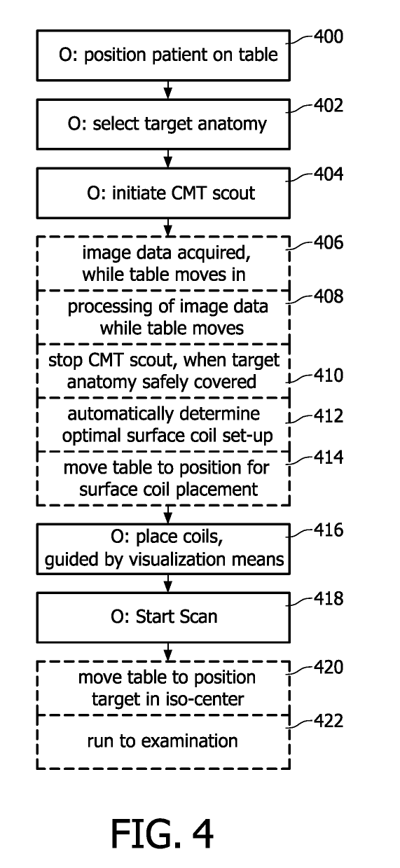

FIG. 4 shows a further flowchart illustrating a method of automatically providing information regarding a surface coil placement on a patient. Compared to the flowchart in FIG. 3, in FIG. 4 it is assumed that surface coils are not yet placed on a patient's body. Therewith, the flowchart in FIG. 4 illustrates a method of guiding an operator where and how to place which kinds of surface coils on the body of the patient.

In step 400, the operator positions the patient on a table and selects in step 402 a respective target anatomy. In step 404, the operator initiates the CMT scout. In step 406, image data is acquired while the table moves into the magnet bore, followed by a real time processing of said image data while the table moves in step 408. As soon as the target anatomy is safely covered within the image acquisition area of the magnet bore the CMT scout is stopped in step 410. In step 412, the optimal surface coil setup is automatically determined by the MR system. After the detection of the optimal surface coil setup in step 412, the table is moved out again in step 414 to allow positioning of a respective surface coil placement by an operator.

In step 416 the operator places the surface coils as suggested by the MR system on the patient, wherein the placement of the surface coil is automatically guided by visualization means like for example a beamer of the MR system. After successful placement of the surface coils on the patient, the operator starts the main scan in step 418. Therewith, the table is moved again into the MR bore in order to position the selected target anatomy in the iso-centre. After this is performed in step 420, the main examination procedure is run in step 422 automatically by the MR system in order to acquire MR image data of the selected target anatomy.

It has to be mentioned, that step 412 comprises besides determining an optimal spatial positioning of the surface coils a determination of an optimal kind of surface coil. In case the system detects that reliable MR data can be acquired without the usage of further surface coils, the MR system may even proceed automatically from step 412 to step 420 to perform image data acquisition using the MR body coil only.

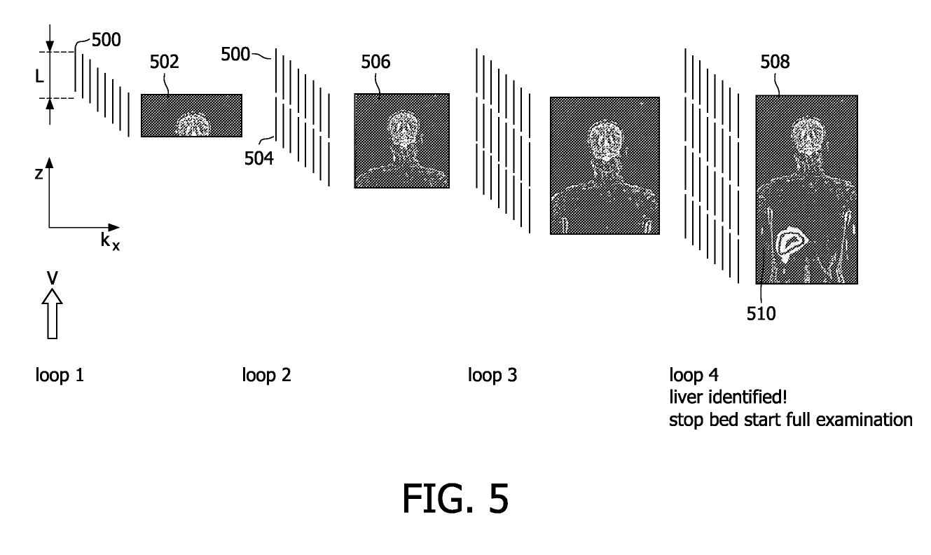

FIG. 5 illustrates the accomplishment of an MR image according to the method of the invention. While acquisition of the MR image 502, the bed supporting a patient is being moved continuously into the magnet bore while image acquisition is performed in a looped fashion. The loop comprises the acquisition of a complete sub-k-space dataset. In a different CMT data acquisition scheme this sub-k-space dataset could correspond to a complete k-space-dataset for an axial (transversal) slice.

The image acquisition update step comprises data with respect to a sensitive volume (local field of view) which is preferably short in the z-direction, which is the direction of table motion. As a special feature of CMT imaging with lateral readout direction, a field of view with z-direction of a few centimeters can be selected, leading to an image update of several seconds per sub-image. This allows for a high image update rate and quick system reaction.

This leads in the present example to a sheared hybrid k-space, wherein in the present example the z-direction of the image data represents the elementary field of view of length L and each step in the phase encoding direction-kₓ represents one sub-k-space acquisition. Due to the sheared arrangement of the acquired sub-k-space images 500, the image reconstruction in order to form the image 502 has to comprise a correction of the table movement in z-direction.

After the set of sub-k-space acquisition steps has been performed in order to form the image 502, this procedure is repeated by further moving the patients bed to form a new set 504 of sub-k-space data to form an MR image 506. In the present example, this procedure is performed for four loops, wherein in the fourth loop the MR system finally identifies a target organ, which in the present example is in the MR image 508 the target organ ‘liver’ 510. As soon as the target organ is identified, the movement of the bed is stopped and the bed is additionally moved to reposition the target organ 510 with respect to the iso-centre of the magnet bore. Finally, the full high resolution MR examination process with means of an MR image data acquisition is started.

### LIST OF REFERENCE NUMERALS

| | |
|---|---|
| 100 | Data processing system |
| 102 | Screen |
| 104 | Input device |
| 106 | Memory |
| 108 | Interface |
| 110 | Processor |
| 112 | computer program product |
| 114 | Module |
| 116 | Module |
| 118 | Database |
| 120 | Module |
| 122 | Main magnet |
| 124 | Gradient coil |
| 126 | Patient |
| 128 | RF body coil |
| 130 | Main field control unit |
| 132 | Gradient coils control unit |
| 134 | RF coils control unit |
| 136 | Amplifier |
| 138 | RF generator |
| 140 | Bed |
| 142 | Surface coil |
| 144 | Bed control unit |
| 146 | Projection unit |
| 500 | Sub-k-space image |
| 502 | MR Image |
| 504 | Sub-k-space image |
| 506 | MR Image |
| 508 | MR Image |
| 510 | Target organ |

1. A method of automatically acquiring magnetic resonance (MR) image data of an object located on a support, the support being adapted to be moved to an image acquisition region of an MRI apparatus, the method comprising:
specifying an area of interest to be detected by the MRI apparatus, automatically moving of the support towards the image acquisition region,
automatically acquiring of first MR image data with a first resolution for identification of the area of interest in the acquired image data while the support is being moved,
automatically acquiring of second MR image data of the identified area of interest with a second resolution, wherein the first resolution is lower than the second resolution.

2. The method of claim 1, wherein the area of interest is specifiable as an anatomic structure, wherein automatically acquiring of the first MR image data for identification of the anatomic structure further comprises detection of anatomic anomalies.

3. The method of claim 1, wherein the area of interest is specifiable as an anatomic anomaly.

4. The method of claim 1, wherein the support is a continuously moving support (110; CMT).

5. The method of claim 4, wherein the first MR image data are acquired in real-time during the continuous moving of the support.

6. The method of claim 1, further comprising automatic adjusting of MR image acquisition parameters for acquisition of the first and/or the second MR image data.

7. The method of claim 6, wherein the automatic adjusting of MR image acquisition parameters is based on analysis of the acquired first and/or second MR image data.

8. The method of claim 1, wherein the identification of the area of interest is performed using image processing, wherein the identification of the area of interest is performed with means of an anatomical database and/or a susceptibility database.

9. The method of claim 1, further comprising real-time susceptibility mapping based on analysis of the first MR image data, wherein in case of identification of a susceptibility distortion the MRI scan is interrupted and/or the MRI scanning parameters are adjusted and/or the moving direction of the support is inverted and/or a signal is generated by the MRI apparatus indicating the identification of the susceptibility distortion.

10. The method of claim 1, wherein the moving of the support is stopped at identification of the area of interest.

11. The method of claim 1, wherein acquisition of the first MR image data is performed at a first zone of the image acquisition region and wherein the acquisition of the second MR image data is performed at a second zone of the image acquisition region, wherein the first zone is spatially located ahead of the second zone with respect to the direction of support movement.

12. The method of claim 1, wherein the first MR image data acquisition is performed using keyhole type sampling.

13. The method of claim 1, wherein the moving speed of the support is varied with respect to anatomies identified with means of the automatic acquisition of the first MR image data.

14. The method of claim 13, wherein the moving speed of the support is reduced when the area of interest is expected to be moved by means of the moving support to the image acquisition region.

15. The method of claim 14, further comprising increasing the spatial resolution for acquiring of the first MR image data when the area of interest is expected to be moved by means of the moving support to the image acquisition region.

16. The method of claim 1, further comprising automatically providing information regarding an optimal spatial positioning of further MRI receive coils relative to the object, the further MRI receive coils being adapted for acquisition of the second MR image data.

17. The method of claim 16, wherein providing of the information regarding an optimal spatial positioning of the further MRI receive coils is based on analysis of the first MR image data and/or if the further MRI receive coils are already spatially positioned on the object to be scanned based on analysis of MR image data acquired from the further MRI receive coils.

18. A magnetic resonance imaging apparatus for automatically acquiring MR images of an object, the apparatus comprising:
a support for an object to be imaged, the support being adapted to be moved to an image acquisition region of the MRI apparatus, means for specifying an area of interest to be detected by the MRI apparatus,
means for automatically moving of the support,
means for automatically acquiring of first MR image data with a first resolution for identification of the area of interest in the acquired image data, while the support is being moved,
means for automatically acquiring of second MR image data of the identified area of interest with a second resolution, wherein the first resolution is lower than the second resolution.

19. The apparatus of claim 18, further comprising:
means for automatically adjusting of MR image acquisition parameters for acquisition of the first and/or the second MR image data,
an anatomical database and/or a susceptibility database,
means for automatically providing information regarding an optimal spatial positioning of further MRI receive coils, the further MRI receive coils being adapted for acquisition of the second MR image data.

20. A computer program product comprising computer executable instructions for performing the method steps of claim 1.
